(19) United States
(12) Patent Application Publication
(10) Pub. No.: US 2025/0010823 A1
(43) Pub. Date: Jan. 9, 2025

(54) VEHICLE CONTROL DEVICE

(71) Applicant: Hitachi Astemo, Ltd., Hitachinaka-shi, Ibaraki (JP)

(72) Inventors: Masato IMAI, Chiyoda-ku, Tokyo (JP); Satoru OKUBO, Chiyoda-ku, Tokyo (JP)

(73) Assignee: Hitachi Astemo, Ltd., Hitachinaka-shi, Ibaraki (JP)

(21) Appl. No.: 18/708,689

(22) PCT Filed: Aug. 2, 2022
(86) PCT No.: PCT/JP2022/029683

§ 371 Date: May 9, 2024

(30) Foreign Application Priority Data
Nov. 29, 2021 (JP) 2021-193175

(51) Int. Cl. B60T 7/22; B60Q 9/00; B60T 8/171; B60T 8/172; B60W 30/09; B60W 30/095; B60W 50/14; B60W 60/00

(52) U.S. Cl. CPC B60T 7/22; B60Q 9/008; B60T 8/171; B60T 8/172; B60W 30/09; B60W 30/0956; B60W 50/14; B60W 60/0015; B60T 2201/022; B60T 2210/32; B60T 2260/08; B60W 2050/143; B60W 2520/00; B60W 2554/402; B60W 2554/404; B60W 2554/4044

(57) ABSTRACT

An object of the present invention is to provide a vehicle control device capable of avoiding the collision with an obstacle by performing an appropriate collision assessment and appropriate driving assistance having considered a detection error of the obstacle. The vehicle control device 100 includes a collision assessment unit 3 which assesses whether or not there is a possibility of an ego vehicle and an obstacle colliding with each other, and a driving assistance control unit 4 which performs driving assistance for avoiding the collision. The collision assessment unit 3 includes a region setting unit 31 which sets an ego vehicle region and an obstacle region, a location prediction unit 33 which predicts future locations of the ego vehicle region and the obstacle region, and an overlap assessment unit 34 which assesses that there is a possibility of collision when the ego vehicle region and the obstacle region overlap at the future location. The region setting unit 31 changes, on the basis of a moving speed of the obstacle, the size of the ego vehicle region and/or the obstacle region from the size of the ego vehicle and/or the obstacle, to thereby set the ego vehicle region and the obstacle region.

### TECHNICAL FIELD

The present invention relates to a vehicle control device, and particularly to a vehicle control device for avoiding collisions with obstacles around a vehicle or reducing damage in the event of collisions.

### BACKGROUND ART

There have been proposed various technologies for detecting obstacles (a vehicle, a motorcycle, a bicycle, a pedestrian or a structure, etc.) around an ego vehicle using an on-vehicle camera or an external world recognition device such as a radar. Further, there has been developed a collision avoidance technology which avoids collision with a detected obstacle or reducing damage at the time of the collision.

Patent Literature 1 is known as this collision avoidance technology. There has been disclosed in Patent Literature 1, a collision avoidance device which, when it is determined that the collision between an ego vehicle and a pedestrian is predicted within a first operation permission range having a predetermined width smaller than within an estimated course of the ego vehicle from the center of the ego vehicle, and it is determined that the current position of the pedestrian is located within a second operation permission range of a predetermined distance to the left and right with respect to the estimated course center of the ego vehicle, executes control to actuate an automatic emergency brake. The technology disclosed in Patent Literature 1 uses the two operation permission ranges as described above to determine whether or not to actuate the automatic brake by determining the collision with the pedestrian crossing in front of the ego vehicle and thereby prevent unnecessary automatic emergency braking beforehand.

### CITATION LIST

### Patent Literature

Patent Literature 1: Japanese Unexamined Patent Application Publication No. 2017-182768

### SUMMARY OF INVENTION

### Technical Problem

A detection error of the position or moving speed of an obstacle may occur in the detection result of each obstacle around an ego vehicle. A problem is likely to occur in that since the time it takes for an object to be detected to pass in front of the ego vehicle becomes shorter in the case where the object is an obstacle faster in moving speed than a pedestrian, such as a vehicle, a motorcycle, or a bicycle, an automatic emergency brake becomes inoperable due to incorrect collision determination or the timing of the automatic emergency brake may be significantly delayed when the detection error is large, so that the collision with the obstacle becomes inevitable. In Patent Literature 1, the above problem may occur because no consideration is given to the detection error of the obstacle fast in moving speed.

The present invention has been made in view of the above, and it is an object of the present invention to provide a vehicle control device capable of avoiding the collision with an obstacle by performing an appropriate collision assessment and appropriate driving assistance having considered a detection error of the obstacle.

### Solution to Problem

In order to solve the above problems, a vehicle control device of the present invention includes: an obstacle detection unit which detects an obstacle in front of an ego vehicle in a traveling direction of the ego vehicle; a course estimation unit which estimates a course of the ego vehicle; a collision assessment unit which assesses whether or not there is a possibility that the ego vehicle will collide with the obstacle; and a driving assistance control unit which provides the ego vehicle with driving assistance for avoiding collision with the obstacle when it is determined that there is the possibility of collision. In the vehicle control device, the collision assessment unit includes: a region setting unit which sets an ego vehicle region in which the ego vehicle exists, and an obstacle region in which the obstacle exits, a location prediction unit which predicts future locations of the ego vehicle region and the obstacle region on the basis of a detection result of the obstacle detection unit and an estimation result of the course estimation unit, and an overlap assessment unit which assesses whether or not the ego vehicle region and the obstacle region overlap at the future location, and assesses that the collision possibility exists when the ego vehicle region and the obstacle region overlap. The region setting unit changes the size of the ego vehicle region and/or the obstacle region from the size of the ego vehicle and/or the obstacle, on the basis of a moving speed of the obstacle, to set the ego vehicle region and the obstacle region.

### Advantageous Effects of Invention

According to the present invention, it is possible to provide a vehicle control device capable of avoiding the collision with an obstacle by performing an appropriate collision assessment and appropriate driving assistance having considered a detection error of the obstacle.

Objects, configurations, and effects other than the above will be apparent from the description of the following embodiments.

### BRIEF DESCRIPTION OF DRAWINGS

FIG. 1 is a diagram describing a functional configuration of a vehicle control device according to the present embodiment.

FIG. 2 is a flowchart of processing performed by the vehicle control device shown in FIG. 1.

FIG. 3 is a flowchart of collision determination processing shown in Step S205 of FIG. 2.

FIG. 4 is a flowchart of driving support control processing shown in Step S207 of FIG. 2.

FIG. 5(a) is a diagram for describing a specific example of collision determination processing, and FIG. 5(b) is a diagram showing a future location of an obstacle predicted when a detection error occurs in an obstacle detection result in a situation shown in FIG. 5(a).

FIG. 6(a) is a diagram describing region setting processing of enlarging an obstacle region by region extension, and FIG. 6(b) is a diagram describing region setting processing of enlarging an obstacle region by region addition.

FIG. 7(a) is a graph describing the amount of enlargement/reduction of the size of the obstacle region set in the region setting processing shown in FIG. 6(a), and FIG. 7(b) is a graph describing the amount of enlargement/reduction of the size of the obstacle region set in the region setting processing shown in FIG. 6(b).

FIG. 8(a) is a diagram describing region setting processing of enlarging an ego vehicle region by region extension, and FIG. 8(b) is a diagram describing region setting processing of enlarging an ego vehicle region by region addition.

FIG. 9(a) is a graph describing the amount of enlargement/reduction of the size of the ego vehicle region set in the region setting processing shown in FIG. 8(a), and FIG. 9(b) is a graph describing the amount of enlargement/reduction of the size of the ego vehicle region set in the region setting processing shown in FIG. 8(b).

FIG. 10(a) is a diagram describing processing of setting an alarm alerting timing, and FIG. 10(b) is a diagram describing processing of setting an operation timing of an automatic emergency brake.

FIG. 11(a) is a diagram describing another example of the setting processing shown in FIG. 10(a), and FIG. 11(b) is a diagram describing another example of the setting processing shown in FIG. 10(b).

FIG. 12 is a diagram describing another example of the vehicle control device shown in FIG. 1.

### DESCRIPTION OF EMBODIMENTS

Hereinafter, embodiments of the present invention will be described with reference to the drawings. It should be noted that components denoted by the same reference numerals in each embodiment have the same function in each embodiment unless otherwise specified, and description thereof will be omitted.

### [Overall Configuration and Operation of Vehicle Control Device]

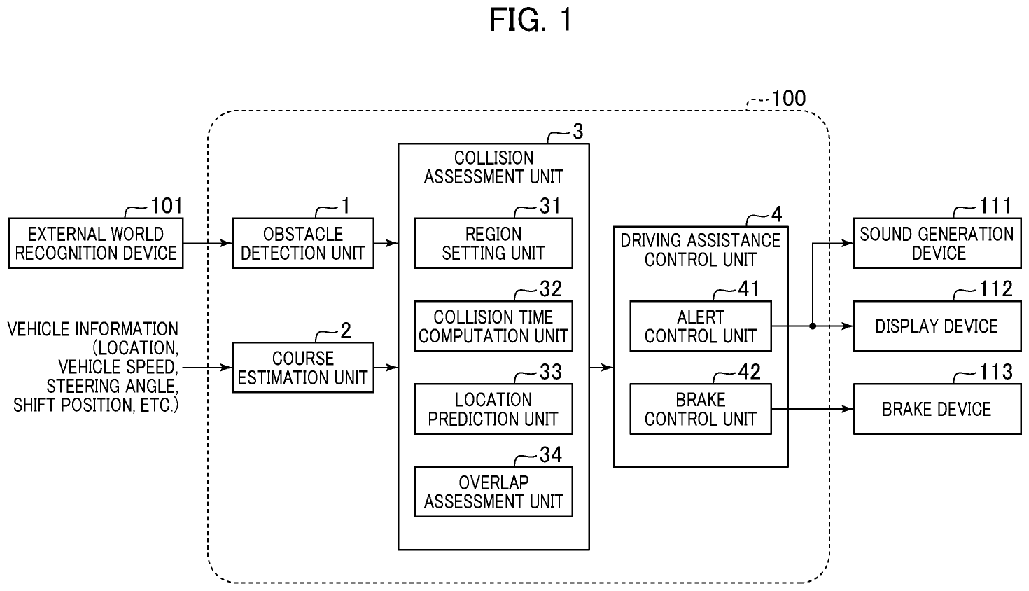

FIG. 1 is a diagram describing a functional configuration of a vehicle control device 100 according to the present embodiment.

The vehicle control device 100 is a computer which controls an ego vehicle, and executes programs stored in an unillustrated storage medium to implement various functions of the vehicle control device 100.

The vehicle control device 100 is connected to a brake device 113 of the ego vehicle, and an external world recognition device 101, a sound generation device 111, and a display device 112 which are provided in the ego vehicle. The vehicle control device 100 is connected to an in-vehicle network (for example, CAN) and a transmission line such as a dedicated line in the ego vehicle. Vehicle information such as the location, vehicle speed, steering angle, and shift position of the ego vehicle is input to the vehicle control device 100 via the transmission line.

The external world recognition device 101 is a device which recognizes a surrounding environment of the ego vehicle and acquires information about the surrounding environment. In particular, the external world recognition device 101 is a device which recognizes a surrounding environment in front of the ego vehicle in its traveling direction and acquires information about the surrounding environment. The external world recognition device 101 is configured by, for example, an in-vehicle camera such as a monocular camera or a stereo camera which captures an image of the surrounding environment. The captured image of the external world recognition device 101 is output to the vehicle control device 100 via a transmission line such as a dedicated line, either as analog data or after being subjected to analog-to-digital conversion. In addition to the in-vehicle camera, the external world recognition device 101 can be configured by a radar which measures the distance to each obstacle using millimeter waves or laser light, or a sonar which measures the distance to each obstacle using ultrasonic waves, or the like. The external world recognition device 101 can output information such as the detected distance to the obstacle, direction, moving speed, type of obstacle, etc. to the vehicle control device 100 via the transmission line.

The sound generation device 111 is configured of a speaker or the like. The sound generation device 111 emits a warning sound, voice guidance or the like (hereinafter also referred to as an “alarm”) indicating that there is a possibility of collision between the ego vehicle and the obstacle and notifies it to an occupant.

The display device 112 is comprised of a display such as a navigation device, a meter panel, a warning light, or the like. The display device 112 displays an operation screen of the vehicle control device 100 and displays an alarm screen or the like which visually informs that there is a possibility of collision between the ego vehicle and the obstacle, to notify the occupant.

The brake device 113 is comprised of an electric or hydraulic brake or the like which can control a braking force using an electric or hydraulic actuator or the like on the basis of a braking command from the outside.

The vehicle control device 100 includes an obstacle detection unit 1, a course estimation unit 2, a collision assessment unit 3, and a driving assistance control unit 4.

The obstacle detection unit 1 detects obstacles existing around the ego vehicle on the basis of the result of recognition of the external world recognition device 101. Specifically, the obstacle detection unit 1 performs obstacle detection processing of detecting information (hereinafter also referred to as “obstacle information”) such as the type, position, shape, size, moving direction, and moving speed or the like of each obstacle existing around the ego vehicle, based on captured image data or ranging data of the surrounding environment of the ego vehicle input from the external world recognition device 101. Types of obstacles include a vehicle, a two-wheeled vehicle, a bicycle, or a pedestrian, etc. The type, position, shape and size, etc. of an obstacle can be detected using pattern matching, but other techniques may be used.

The course estimation unit 2 performs ego vehicle course estimation processing of estimating the future course of the ego vehicle on the basis of the vehicle information such as the vehicle speed, steering angle, shift position, and the like of the ego vehicle input from the transmission line connected to the vehicle control device 100.

The collision assessment unit 3 performs collision assessment processing of assessing for the presence of a possibility that the ego vehicle will collide with an obstacle. In particular, the collision assessment unit 3 performs collision assessment processing of assessing whether there is a possibility of collision between an obstacle which crosses in front of the ego vehicle in the traveling direction, and the ego vehicle.

The collision assessment unit 3 compares the course of ego vehicle estimated by the course estimation unit 2 with the future location of the obstacle detected by the obstacle detection unit 1, to assess for the presence of a possibility that the ego vehicle will collide with the obstacle. The collision assessment unit 3 performs a collision assessment using the ego vehicle region and the obstacle region so that the collision assessment is appropriately performed. The ego vehicle region is a region where the ego vehicle exists. The ego vehicle region may be a region occupied by the ego vehicle. The obstacle region is a region where the obstacle exists. The obstacle region may be a region occupied by the obstacle. The collision assessment unit 3 virtually changes the size of the ego vehicle region and/or the obstacle region to perform a collision assessment. The amount of enlargement/reduction of the size of the ego vehicle region and the obstacle region is set in advance so as to be variable according to the moving speed and the like of the obstacle.

The collision assessment unit 3 includes a region setting unit 31, a collision time computation unit 32, a location prediction unit 33, and an overlap assessment unit 34.

The region setting unit 31 performs region setting processing of setting the ego vehicle region and the obstacle region. The region setting unit 31 sets the ego vehicle region on the basis of the vehicle information of the ego vehicle input from the transmission line and the course of the ego vehicle estimated by the course estimation unit 2. The region setting unit 31 sets the obstacle region on the basis of the obstacle information detected by the obstacle detection unit 1. For example, the region setting unit 31 may specify an obstacle crossing the course of the ego vehicle from the obstacle information detected by the obstacle detection unit 1 and the course of the ego vehicle estimated by the course estimation unit 2. The region setting unit 31 may set the obstacle region of the specified obstacle from the obstacle information detected by the obstacle detection unit 1.

In the region setting processing, the region setting unit 31 virtually changes the size of the ego vehicle region and/or the obstacle region from the size of the ego vehicle and/or the obstacle, based on the moving speed of the obstacle. Specifically, the region setting unit 31 changes the size (length) of the ego vehicle region and/or the obstacle region in the direction crossing the course of the ego vehicle from the size (length) of the ego vehicle and/or the obstacle in the crossing direction, based on the moving speed of the obstacle in the crossing direction. Then, the region setting unit 31 sets the changed ego vehicle region and/or obstacle region.

At this time, the region setting unit 31 sets the size of the ego vehicle region and/or the obstacle region in the crossing direction to be enlarged as the moving speed of the obstacle in the direction crossing the course of the ego vehicle increases. The region setting unit 31 sets the size of the ego vehicle region and/or the obstacle region in the crossing direction to be reduced as the moving speed of the obstacle in the crossing direction becomes lower. Note that the direction crossing the course of the ego vehicle may be the traveling direction of the obstacle when the obstacle traverses the course of the ego vehicle, or may be the width direction of the ego vehicle when the obstacle traverses the course of the ego vehicle.

The collision time computation unit 32 performs collision time computation processing of calculating a collision time TTC (Time To Collision) which is the time required for the ego vehicle to collide with an obstacle, based on the result of detection by the obstacle detection unit 1 and the result of estimation by the course estimation unit 2. For example, the collision time computation unit 32 can estimate the course of the obstacle from the location, moving direction, and moving speed of the obstacle included in the obstacle information detected by the obstacle detection unit 1. The collision time computation unit 32 estimates as the collision location of the ego vehicle and the obstacle, a location where the estimated course of the obstacle traverses the course of the ego vehicle estimated by the course estimation unit 2. The collision time computation unit 32 divides the distance from the current location of the ego vehicle to the collision location by the vehicle speed of the ego vehicle. Thus, the collision time computation unit 32 can calculate the collision time TTC. The collision time computation unit 32 may calculate the collision time TTC using another method.

The location prediction unit 33 performs location prediction processing of predicting the future locations of the ego vehicle region and the obstacle region, based on the detection result of the obstacle detection unit 1 and the estimation result of the course estimation unit 2. Specifically, the location prediction unit 33 predicts the locations of the ego vehicle region and the obstacle region when the collision time TTC counted down according to the lapse of time becomes zero. That is, the location prediction unit 33 predicts the locations of the ego vehicle region and the obstacle region when assuming that the ego vehicle region and the obstacle region move at the current vehicle speed of the ego vehicle and the moving speed of the obstacle, respectively, until the collision time TTC elapses.

Note that the location prediction unit 33 can predict the future location of the obstacle region from the location, moving direction, and moving speed of the obstacle included in the obstacle information detected by the obstacle detection unit 1. The location prediction unit 33 can estimate the future location of the ego vehicle region from the location, vehicle speed, and steering angle of the ego vehicle included in the vehicle information of the ego vehicle input from the transmission line, and the course of the ego vehicle estimated by the course estimation unit 2.

The overlap assessment unit 34 assesses whether or not the ego vehicle region and the obstacle region overlap at the future location predicted by the location prediction unit 33. When the ego vehicle region and the obstacle region overlap, the overlap assessment unit 34 assesses that there is a possibility that the ego vehicle will coincide with the obstacle.

Specifically, the overlap assessment unit 34 performs overlap amount computation processing of calculating an overlap amount indicating the degree of overlap between the ego vehicle region and the obstacle region at the positions of the ego vehicle region and the obstacle region when the collision time TTC becomes zero. The amount of overlap is the size (length) of the overlapping portion of the ego vehicle region and the obstacle region in the direction crossing the course of the ego vehicle. Then, the overlap assessment unit 34 assesses whether or not the calculated overlap amount is zero. When the calculated overlap amount is zero, the overlap assessment unit 34 assesses that there is no possibility of the ego vehicle colliding with the obstacle. When the calculated overlap amount is not zero, the overlap assessment unit 34 assesses that there is the possibility of collision.

Further, when the size of the ego vehicle region and/or the obstacle region in the direction in which the obstacle crosses the course of the ego vehicle is changed, the overlap assessment unit 34 calculates the overlap rate between the ego vehicle region and the obstacle region in the changed region. The overlap rate is the ratio of the size (overlap amount) of the overlap portion between the ego vehicle region and the obstacle region in the crossing direction to the size of the region whose size has been changed in the crossing direction. In particular, when the size of the ego vehicle region and/or the obstacle region in the crossing direction is enlarged, the overlap assessment unit 34 calculates the overlap rate in the enlarged region.

When the collision assessment unit 3 assesses that there is a possibility that the ego vehicle will collide with the obstacle, the driving assistance control unit 4 performs driving assistance control processing of providing the ego vehicle with driving assistance to avoid collision with the obstacle.

The driving assistance control unit 4 includes an alert control unit 41 and a brake control unit 42.

The alert control unit 41 controls alerting of an alarm to the occupant of the ego vehicle. When the collision assessment unit 3 assesses that there is a possibility of collision, the alert control unit 41 performs setting processing of setting an alert timing of the alarm. At this time, the alert control unit 41 sets the alert timing of the alarm on the basis of the moving speed of the obstacle in the direction crossing the course of the ego vehicle. Also, the alert control unit 41 sets the alert timing of the alarm based on the overlap rate calculated by the overlap assessment unit 34.

The alert control unit 41 sets a value (hereinafter also referred to as an “alarm start TTC”) which defines the collision time TTC counted down with the elapse of time, at which to start the alerting of the alarm, thereby to set the alert timing of the alarm. The alert control unit 41 determines whether or not the set alert timing has arrived by determining whether or not the collision time TTC falls below the alarm start TTC. When the alert timing arrives, the alert control unit 41 performs alarm output processing of outputting an alarm to the sound generation device 111 and the display device 112.

The brake control unit 42 controls the operation of the automatic emergency brake of the ego vehicle. When the collision assessment unit 3 assesses that there is a possibility of collision, the brake control unit 42 performs setting processing of setting the operation timing of the automatic emergency brake. At this time, the brake control unit 42 sets the operation timing of the automatic emergency brake on the basis of the moving speed of the obstacle in the direction crossing the course of the ego vehicle. Also, the brake control unit 42 sets the operation timing of the automatic emergency brake on the basis of the overlap rate calculated by the overlap assessment unit 34.

The brake control unit 42 sets a value (hereinafter also referred to as a “brake operation start TTC”) which defines the collision time TTC counted down with the elapse of time, at which to start the operation of the automatic emergency brake, thereby to set the operation timing of the automatic emergency brake. The brake control unit 42 determines whether or not the set operation timing has arrived by determining whether or not the collision time TTC falls below the brake operation start TTC. When the operation timing arrives, the brake control unit 42 performs brake control amount calculation processing of calculating a brake control amount which generates a braking fore that is capable of avoiding collision with an obstacle. The brake control amount is, for example, target brake pressure or the like, but may not be the target brake pressure as long as it is a control amount according to the configuration of the brake device 113. After that, the brake control unit 42 performs brake control amount output processing of outputting the calculated brake control amount to the brake device 113 to cause the brake device 113 to actuate the automatic emergency brake.

Note that, as described above, the region setting unit 31 included in the collision assessment unit 3 can change and set the size of the ego vehicle region and/or the obstacle region before the location prediction unit 33 predicts the locations of the ego vehicle region and the obstacle region when the collision time TTC becomes zero. However, when the obstacle is detected, the region setting unit 31 may set the ego vehicle region and the obstacle region having the sizes of the ego vehicle and the obstacle in the direction crossing the course of the ego vehicle. Then, after the location prediction unit 33 predicts the locations of the ego vehicle region and the obstacle region when the collision time TTC becomes zero, the region setting unit 31 may change the sizes of the ego vehicle region and/or the obstacle region in the crossing direction at the corresponding locations to reset the ego vehicle region and/or the obstacle region.

Further, as described above, the location prediction unit 33 included in the collision assessment unit 3 can predict the locations of the ego vehicle region and the obstacle region when the collision time TTC becomes zero, as the future locations of the ego vehicle region and the obstacle region. The overlap assessment unit 34 can assess whether or not the ego vehicle region and the obstacle region overlap at the locations of the ego vehicle region and the obstacle region when the collision time TTC becomes zero. Consequently, the vehicle control device 100 can determine whether there is a possibility of collision of the ego vehicle with the obstacle while suppressing a processing load on the location prediction unit 33 and the overlap assessment unit 34.

On the other hand, the location prediction unit 33 may predict as the future locations of the ego vehicle region and the obstacle region, not only the locations of the ego vehicle region and the obstacle region when the collision time TTC becomes zero, but also the locations of the ego vehicle region and the obstacle region at a plurality of points of time in the future. Then, the overlap assessment unit 34 may assess whether or not the ego vehicle region and the obstacle region overlap each time at a plurality of locations predicted at multiple points of time in the future. Consequently, the vehicle control device 100 can accurately determine whether or not there is a possibility of the ego vehicle colliding with the obstacle even if the moving direction and moving speed of the obstacle change moment by moment.

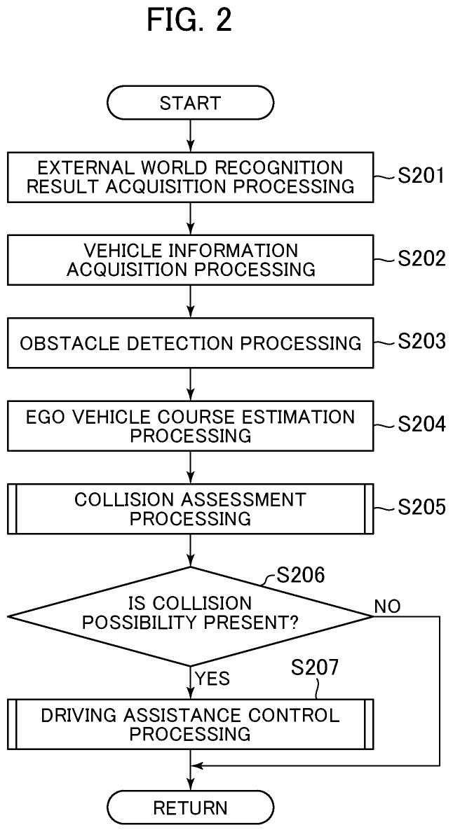

FIG. 2 is a flowchart of processing performed by the vehicle control device 100 shown in FIG. 1.

In Step S201, the vehicle control device 100 performs external world recognition result acquisition processing of acquiring a recognition result of a surrounding environment of the ego vehicle (hereinafter also referred to as an “external world recognition result”) from the external world recognition device 101. In particular, the vehicle control device 100 acquires a recognition result of an obstacle present in front of the ego vehicle in the traveling direction.

In Step S202, the vehicle control device 100 performs vehicle information acquisition processing of acquiring vehicle information from the transmission line connected to the vehicle control device 100.

In Step S203, the vehicle control device 100 performs obstacle detection processing of detecting obstacle information on the basis of the external world recognition result acquired in Step S201.

In Step S204, the vehicle control device 100 performs ego vehicle course estimation processing of estimating the future course of the ego vehicle on the basis of the vehicle information acquired in Step S202.

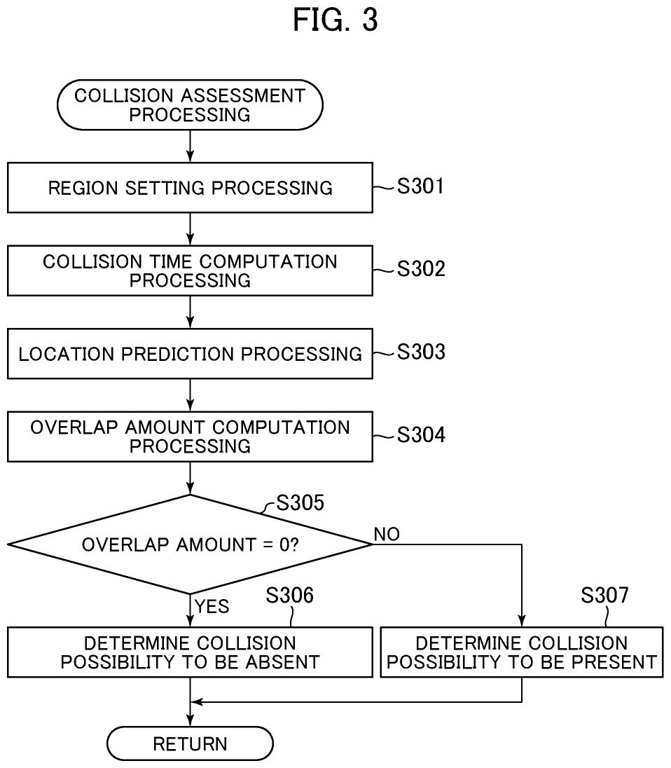

In Step S205, the vehicle control device 100 performs collision assessment processing of assessing whether or not there is a possibility that the ego vehicle will collide with the obstacle. Details of the collision assessment processing will be described later with reference to FIG. 3.

In Step S206, the vehicle control device 100 determines whether the determination result of the collision determination processing in Step S205 indicates that there is a possibility of collision. When the determination result of the collision determination processing indicates that there is the possibility of collision, the vehicle control device 100 proceeds to Step S207. When the determination result of the collision determination processing does not indicate that there is the possibility of collision, the vehicle control device 100 ends this processing shown in FIG. 2.

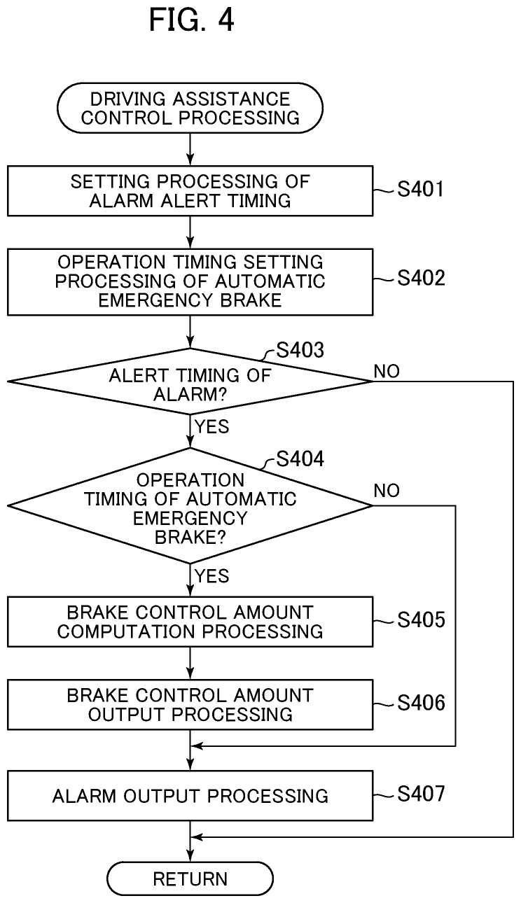

In Step S207, the vehicle control device 100 performs driving assistance control processing of performing driving assistance to the ego vehicle, in order to avoid collision with an obstacle. After that, the vehicle control device 100 ends this processing shown in FIG. 2. Details of the driving assistance control processing will be described later with reference to FIG. 4.

FIG. 3 is a flowchart of the collision determination processing shown in Step S205 of FIG. 2.

In Step S301, the vehicle control device 100 performs region setting processing of setting the ego vehicle region and the obstacle region. At this time, the vehicle control device 100 virtually changes the size of the ego vehicle region and/or the obstacle region in the direction crossing the course of the ego vehicle, thereby to set the ego vehicle region and the obstacle region.

In Step S302, the vehicle control device 100 performs collision time computation processing of calculating the collision time TTC which is the time required for the ego vehicle to collide with an obstacle.

In Step S303, the vehicle control device 100 performs location prediction processing of predicting the locations of the ego vehicle region and the obstacle region when the collision time TTC becomes zero, as the future locations of the ego vehicle region and the obstacle region.

In Step S304, the vehicle control device 100 performs overlap amount computation processing of calculating an overlap amount indicating the degree of overlap between the ego vehicle region and the obstacle region at the locations predicted in Step S303.

In Step S305, the vehicle control device 100 determines whether or not the overlap amount calculated in Step S304 is zero. When the overlap amount is zero, the vehicle control device 100 proceeds to Step S306. When the overlap amount is not zero, the vehicle control device 100 proceeds to Step S307.

In Step S306, the vehicle control device 100 determines that there is no possibility of collision of the ego vehicle with an obstacle. After that, the vehicle control device 100 ends this processing shown in FIG. 3.

In Step S307, the vehicle control device 100 determines that there is a possibility that the ego vehicle will collide with an obstacle. After that, the vehicle control device 100 ends this processing shown in FIG. 3.

FIG. 4 is a flowchart of the driving assistance control processing shown in Step S207 of FIG. 2.

In Step S401, the vehicle control device 100 performs setting processing of setting the alert timing of the alarm. Specifically, the vehicle control device 100 sets the alarm start TTC.

In Step S402, the vehicle control device 100 performs setting processing of setting the operation timing of the automatic emergency brake. Specifically, the vehicle control device 100 sets the brake operation start TTC.

In Step S403, the vehicle control device 100 determines whether or not the alert timing of the alarm has arrived. Specifically, the vehicle control device 100 determines whether or not the collision time TTC falls below the alarm start TTC set in Step S401. When the collision time TTC falls below the alarm start TTC, the vehicle control device 100 determines that the alert timing of the alarm has arrived, and proceeds to Step S404. When the collision time TTC does not fall below the alarm start TTC, the vehicle control device 100 ends this processing shown in FIG. 4.

In Step S404, the vehicle control device 100 determines whether or not the operation timing of the automatic emergency brake has arrived. Specifically, the vehicle control device 100 determines whether or not the collision time TTC falls below the brake operation start TTC set in Step S402. When the collision time TTC falls below the brake operation start TTC, the vehicle control device 100 determines that the operation timing of the automatic emergency brake has arrived, and proceeds to Step S405. When the collision time TTC does not fall below the brake operation start TTC, the vehicle control device 100 determines that the operation timing of the automatic emergency brake does not arrive, and proceeds to Step S407.

In Step S405, the vehicle control device 100 performs brake control amount computation processing of calculating a brake control amount which generates a braking force capable of avoiding collision with an obstacle.

In Step S406, the vehicle control device 100 performs brake control amount output processing of outputting the brake control amount calculated in Step S405 to the brake device 113 to cause the brake device 113 to actuate the automatic emergency brake. Incidentally, when it is not possible to avoid the collision with the obstacle, the vehicle control device 100 outputs a predetermined maximum brake control amount to the brake device 113.

In Step S407, the vehicle control device 100 performs alarm output processing of causing the sound generation device 111 and the display device 112 to output an alarm. Thereafter, the vehicle control device 100 ends this processing shown in FIG. 4.

Even if the moving speed of the obstacle crossing the front of the ego vehicle in the traveling direction thereof is fast, and the detection error of the location or moving speed of the obstacle occurs in the detection result of the obstacle, the vehicle control device 100 is capable of performing an appropriate collision assessment having considered the detection error by performing the processing shown in FIGS. 2 to 4. Therefore, when there is the possibility that the ego vehicle will collide with the obstacle, the vehicle control device 100 can reduce the frequency with which the alerting of the alarm or the operation of the automatic emergency brake is not performed or is delayed. Thus, the vehicle control device 100 can avoid the collision with the obstacle by performing an appropriate collision assessment and appropriate driving assistance having considered the detection error of the obstacle.

In the processing shown in FIG. 3, the region setting unit 31 changes, based on the moving speed of the obstacle in the direction crossing the course of the ego vehicle, the size of the ego vehicle region and/or the obstacle region in the crossing direction from the size of the ego vehicle and/or the obstacle in the crossing direction, to thereby set the ego vehicle region and the obstacle region. This makes it easier for the vehicle control device 100 to determine that there is the possibility that the ego vehicle will collide with the obstacle, because the ego vehicle region and the obstacle region are more likely to overlap. Therefore, the vehicle control device 100 can further reduce the frequency with which the alerting of the alarm or the operation of the automatic emergency brake is not performed or is delayed. Thus, the vehicle control device 100 can more reliably avoid the collision with an obstacle 600 by performing an appropriate collision assessment and appropriate driving assistance having considered a detection error of the obstacle 600.

### [Specific Example of Collision Assessment Processing]

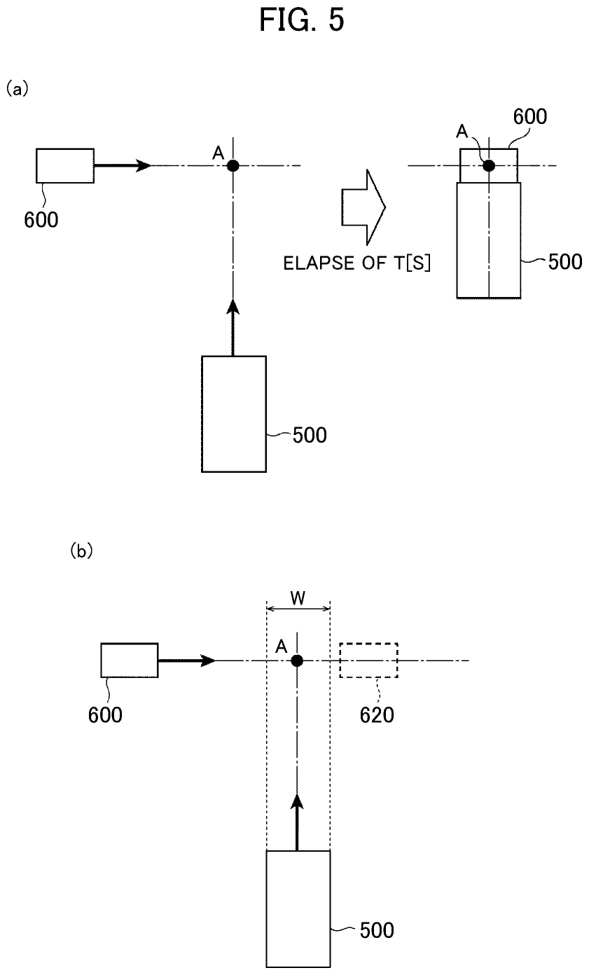

FIG. 5(a) is a diagram for describing a specific example of the collision assessment processing. FIG. 5(b) is a diagram showing a future location 620 of the obstacle 600 which is predicted when a detection error occurs in the detection result of the obstacle 600 in a situation shown in FIG. 5(a).

FIGS. 5(a) and 5(b) assume a situation in which the obstacle 600 exists in front of a straight-traveling ego vehicle 500 in its traveling direction, and the obstacle 600 is about to cross the course of the ego vehicle 500 from the direction perpendicular to the traveling direction of the ego vehicle 500. The left diagram of FIG. 5(a) shows a positional relationship between the ego vehicle 500 and the obstacle 600 and shows the manner in which at a location A, the obstacle 600 crosses the course of the ego vehicle 500. The right diagram of FIG. 5(a) shows a positional relationship between the two after T seconds (collision time TTC=T seconds) from the right diagram of FIG. 5(a) and shows the manner in which the two collide. In the situation shown in FIG. 5(a), the vehicle control device 100 alerts an alarm to an occupant of the ego vehicle 500 at an appropriate timing to actuate the automatic emergency brake at an appropriate timing, thereby making it possible to avoid the collision with the obstacle 600.

FIG. 5(b) shows the same situation as the left diagram of FIG. 5(a). When a detection error in the location or moving speed occurs in the detection result of the obstacle 600, and the location or moving speed including the detection error is used to predict the future location of the obstacle 600 after T seconds, the obstacle 600 is predicted to move to the future location 620. Actually, as shown in the right diagram of FIG. 5(a), the obstacle 600 collides with the front of the ego vehicle 500 after T seconds, but as shown in FIG. 5(b), the obstacle 600 is predicted to move to the future location 620 where it has passed the front of the ego vehicle 500. Then, it may be determined that there is no possibility of collision of the ego vehicle 500 with the obstacle 600, and the alerting of the alarm or the operation of the automatic emergency brake may not be performed.

Therefore, the vehicle control device 100 performs the above region setting processing in order to appropriately assess the collision between the ego vehicle 500 and the obstacle 600 and perform the alerting of the alarm or the operation of the automatic emergency brake at an appropriate timing.

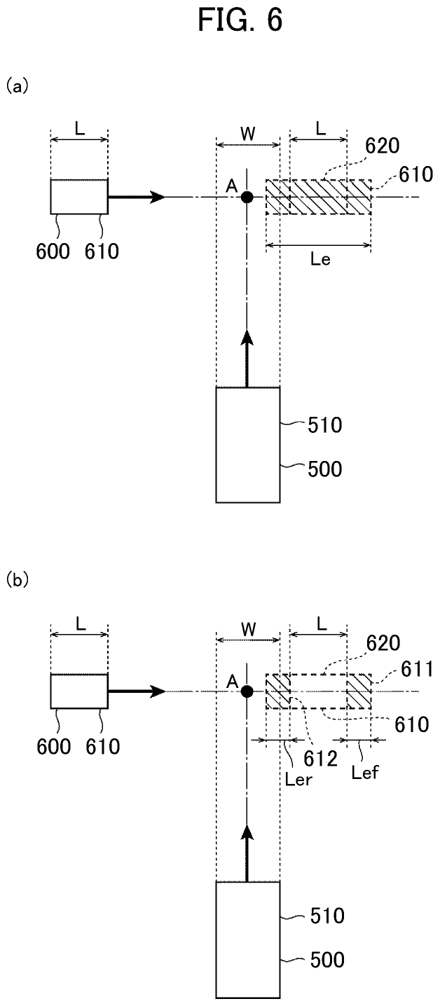

FIG. 6(a) is a diagram describing the region setting processing of enlarging an obstacle region 610 by region extension. FIG. 6(b) is a diagram describing the region setting processing of enlarging the obstacle region 610 by region addition.

FIGS. 6(a) and 6(b) show the same situation as FIG. 5(b). In order to perform the appropriate assessment of collision between the ego vehicle 500 and the obstacle 600, the region setting unit 31 performs region setting processing of enlarging the obstacle region 610 at the future location 620 after T seconds. In the example of FIG. 6(a), when the size of the obstacle 600 (obstacle region 610 before its enlargement) in the direction crossing the course of the ego vehicle 500 is L, the region setting unit 31 extends the size of the obstacle region 610 in the crossing direction to Le at the future location 620 after T seconds. That is, in the example of FIG. 6(a), the region setting unit 31 enlarges the size of the obstacle region 610 in the crossing direction by extending the obstacle region 610 itself in the crossing direction. On the other hand, in the example of FIG. 6(b), the region setting unit 31 adds small regions 611 and 612 before and after the pre-enlargement obstacle region 610 at the future location 620 after T seconds to enlarge the size of the obstacle region 610 in the crossing direction. In FIG. 6(b), Lef indicates the size of the small region 611 in the crossing direction. Ler indicates the size of the small region 612 in the crossing direction.

By performing the region setting processing shown in FIGS. 6(a) and 6(b), the side part of the enlarged obstacle region 610 overlaps with the front part (size W) of the ego vehicle region 510 at the future location 620 after T seconds. Thus, the vehicle control device 100 can determine that there is a possibility that the ego vehicle 500 will collide with the obstacle 600.

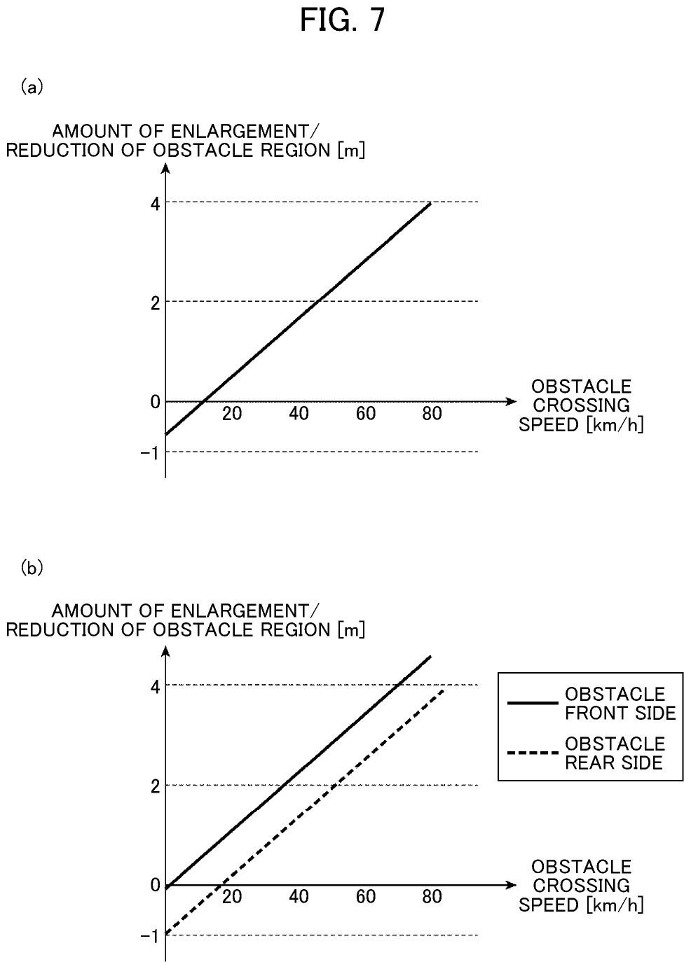

FIG. 7(a) is a graph describing the amount of enlargement/reduction of the size of the obstacle region 610 set in the region setting processing shown in FIG. 6(a). FIG. 7(b) is a graph describing the amount of enlargement/reduction of the size of the obstacle region 610 set in the region setting processing shown in FIG. 6(b).

FIGS. 7(a) and 7(b) show that based on the moving speed of the obstacle 600 in the direction crossing the course of the ego vehicle 500 (hereinafter also referred to as a crossing speed of the obstacle 600″), the amount of enlargement/reduction of the size of the obstacle region 610 in the crossing direction is set. The amount of enlargement/reduction of the obstacle region 610 shown in FIG. 7(a) indicates the amount by which the size of the obstacle region 610 in the crossing direction is extended or shortened. The amount of enlargement/reduction of the obstacle region 610 shown in FIG. 7(b) indicates the size of the small region 611 added to or deleted from the front side of the pre-change obstacle region 610 and the side of the small region 612 added to or deleted from the rear side of the pre-change obstacle region 610.

The higher the crossing speed of the obstacle 600, the shorter the time it takes the obstacle 600 to pass in front of the ego vehicle 500, and the more the detection error in the location or moving speed of the obstacle 600 is likely to be large. In FIGS. 7(a) and 7(b), the faster the crossing speed of the obstacle 600, the larger the amount of enlargement of the size of the obstacle region 610 in the crossing direction. That is, the region setting unit 31 enlarges and sets the size of the obstacle region 610 in the crossing direction as the crossing speed of the obstacle 600 increases. This makes it easier for the vehicle control device 100 to determine that there is a possibility that the ego vehicle 500 will collide with the obstacle 600 because the ego vehicle region 510 and the obstacle region 610 are likely to overlap. Therefore, the vehicle control device 100 can further reduce the frequency with which the alerting of the alarm or the operation of the automatic emergency brake is not performed or is delayed. Thus, the vehicle control device 100 can perform an appropriate collision assessment and appropriate driving assistance having considered the detection error of the obstacle 600 to more reliably avoid collision with the obstacle 600.

On the other hand, the lower the crossing speed of the obstacle 600, the smaller the detection error in the location or moving speed of the obstacle 600, and the easier it is to set the accurate obstacle region 610. In FIGS. 7(a) and 7(b), the slower the crossing speed of the obstacle 600, the smaller the amount of enlargement of the size of the obstacle region 610 in the crossing direction. That is, the region setting unit 31 reduces and sets the size of the obstacle region 610 in the crossing direction as the crossing speed of the obstacle 600 decreases. Consequently, the vehicle control device 100 can accurately determine the possibility of the ego vehicle 500 colliding with the obstacle 600 even without making the size of the ego vehicle region 510 and the obstacle region 610 in the crossing direction not so large. Therefore, the vehicle control device 100 can reduce the frequency with which the alerting of the alarm or the operation of the automatic emergency brake is excessively performed. Thus, the vehicle control device 100 is capable of avoiding collision with the obstacle 600 by performing appropriate collision assessment and appropriate driving assistance having considered the detection error of the obstacle 600.

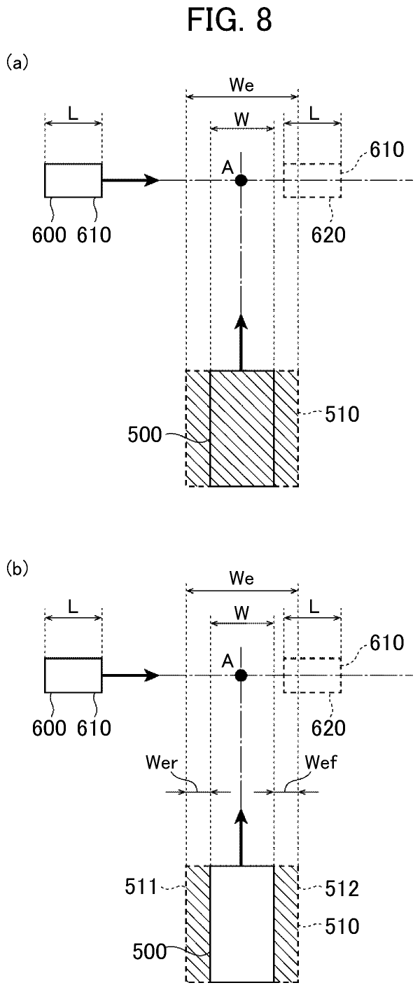

FIG. 8(a) is a diagram describing the region setting processing of enlarging the ego vehicle region 510 and by region extension. FIG. 8(b) is a diagram describing the region setting processing of enlarging the ego vehicle region 510 by region addition.

FIGS. 8(a) and 8(b) show the same situation as FIG. 5(b). In order to perform the appropriate assessment of collision between the ego vehicle 500 and the obstacle 600, the region setting unit 31 performs region setting processing of enlarging the ego vehicle region 510 at the future location 620 after T seconds. In the example of FIG. 8(a), when the size of the ego vehicle 500 (ego vehicle region 510 before its enlargement) in the direction crossing the course of the ego vehicle 500 is W, the region setting unit 31 extends the size of the ego vehicle region 510 in the crossing direction to We at the future location 620 after T seconds. On the other hand, in the example of FIG. 8(b), the region setting unit 31 adds small regions 511 and 512 to the left and right of the ego vehicle region 510 before its enlargement at the future location 620 after T seconds to enlarge the size of the ego vehicle region 510 in the crossing direction. In FIG. 8(b), Wer indicates the size of the small region 511 in the crossing direction. Wef indicates the size of the small region 512 in the crossing direction.

Note that the region setting unit 31 does not set a region occupied by the entire ego vehicle 500 as the ego vehicle region 510, but may set only a region occupied by a portion thereof likely to collide with the obstacle 600 like the front bumper portion of the ego vehicle 500. Likewise, the region setting unit 31 does not set a region occupied by the entire obstacle 600 as the obstacle region 610, but may set only a region occupied by a portion thereof likely to collide with the ego vehicle 500 like the side part of the obstacle 600.

By performing the region setting processing shown in FIGS. 8(a) and 8(b), the front part of the enlarged ego vehicle region 510 overlaps with the side part (size L) of the obstacle region 610 at the future location 620 after T seconds. Thus, the vehicle control device 100 can determine that there is a possibility that the ego vehicle 500 will collide with the obstacle 600.

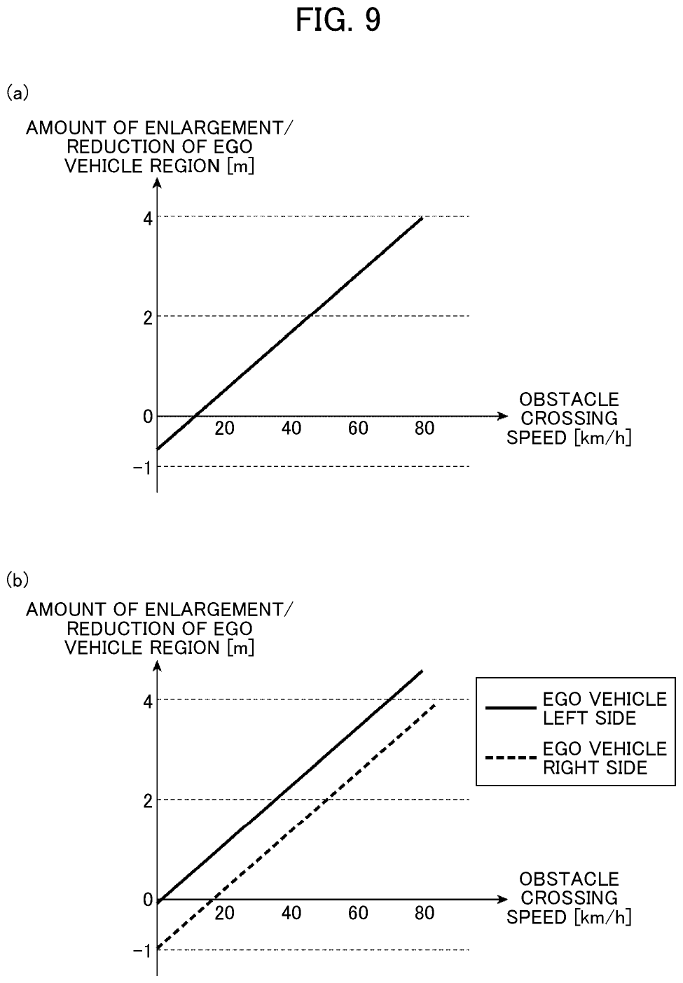

FIG. 9(a) is a graph describing the amount of enlargement/reduction of the size of the ego vehicle region 510 set in the region setting processing shown in FIG. 8(a). FIG. 9(b) is a graph describing the amount of enlargement/reduction of the size of the ego vehicle region 510 set in the region setting processing shown in FIG. 8(b).

FIGS. 9(a) and 9(b) show that the amount of enlargement/reduction of the size of the ego vehicle region 510 in the crossing direction is set based on the crossing speed of the obstacle 600. The amount of enlargement/reduction of the ego vehicle region 510 shown in FIG. 9(a) indicates the amount by which the size of the ego vehicle region 510 in the crossing direction is extended or shortened. The amount of enlargement/reduction of the ego vehicle region 510 shown in FIG. 9(b) indicates the size of the small region 511 added to or deleted from the left side of the pre-change ego vehicle region 510 and the size of the small region 512 added to or deleted from the right side of the pre-change ego vehicle region 510.

Also in FIGS. 9(a) and 9(b), as with FIGS. 7(a) and 7(b), the region setting unit 31 enlarges and sets the size of the ego vehicle region 510 in the crossing direction as the crossing speed of the obstacle 600 increases. The region setting unit 31 reduces and sets the size of the ego vehicle region 510 in the crossing direction as the crossing speed of the obstacle 600 decreases. The vehicle control device 100 can perform an appropriate collision assessment and appropriate driving assistance having considered the detection error of the obstacle 600 to avoid collision with the obstacle 600.

Here, it is desirable that the amount of enlargement/reduction of the size of the ego vehicle region and/or the obstacle region such as shown in FIGS. 7(a) and 7(b) and FIGS. 9(a) and 9(b) is set based on the characteristics of the external world recognition device 101. The characteristics of the external world recognition device 101 include, for example, characteristics related to a recognition error. The recognition error of the external world recognition device 101 tends to fluctuate depending on the location within the recognizable range of the external world recognition device 101. For example, the recognizable range of the external world recognition device 101 provided in the ego vehicle can be represented as a fan-shaped angular range which spreads to both sides in the left/right direction with the optical axis of the external world recognition device 101 as zero angles when viewed from above the ego vehicle. The farther the location is from the optical axis to the left and right within the angular range, the more the external world recognition device 101 tends to recognize the size of the obstacle to be larger than the true value, resulting in a larger recognition error. The larger the recognition error of the external world recognition device 101, the larger the detection error of the obstacle by the obstacle detection unit 1. Therefore, for example, in this case, it is considered that the region setting unit 31 sets the amount of enlargement/reduction of the size of the ego vehicle region and/or the obstacle region conservatively at the location where the recognition error of the external world recognition device 101 is large, rather than at the location where the recognition error is small (sets the absolute value of the amount of enlargement/reduction to be small).

Thus, the region setting unit 31 can change the size of the ego vehicle region and/or the obstacle region, based on the characteristics related to the recognition error of the external world recognition device 101. Consequently, the vehicle control device 100 can set the size of the ego vehicle region and/or the obstacle region to an appropriate size and can accurately determine the possibility of the ego vehicle colliding with the obstacle. The vehicle control device 100 can avoid collision with the obstacle by performing an appropriate collision assessment and appropriate driving assistance having considered the detection error of the obstacle.

Further, it is desirable that the amount of enlargement/reduction of the size of the ego vehicle region and/or the obstacle region is set on the basis of the type of obstacle. For example, when vehicles and pedestrians are compared in terms of the type of obstacle, the pedestrians are likely to make sudden directional turns and sudden changes in speed. Therefore, when the type of obstacle is a pedestrian, the obstacle detection error tends to be larger than when it is a vehicle. Thus, it is considered that for example, when the type of obstacle is a pedestrian, the region setting unit 31 sets the amount of enlargement/reduction of the size of the ego vehicle region and/or the obstacle region more conservatively than when it is of the vehicle (sets the absolute value of the amount of enlargement/reduction to be small).

Thus, the region setting unit 31 can change the size of the ego vehicle region and/or the obstacle region on the basis of the type of obstacle. Consequently, the vehicle control device 100 can set the size of the ego vehicle region and/or the obstacle region to an appropriate size, and can accurately assess the possibility of the ego vehicle colliding with the obstacle. The vehicle control device 100 can avoid collision with the obstacle by performing an appropriate collision assessment and appropriate driving assistance having considered the detection error of the obstacle.

### [Specific Example of Driving Assistance Control Processing]

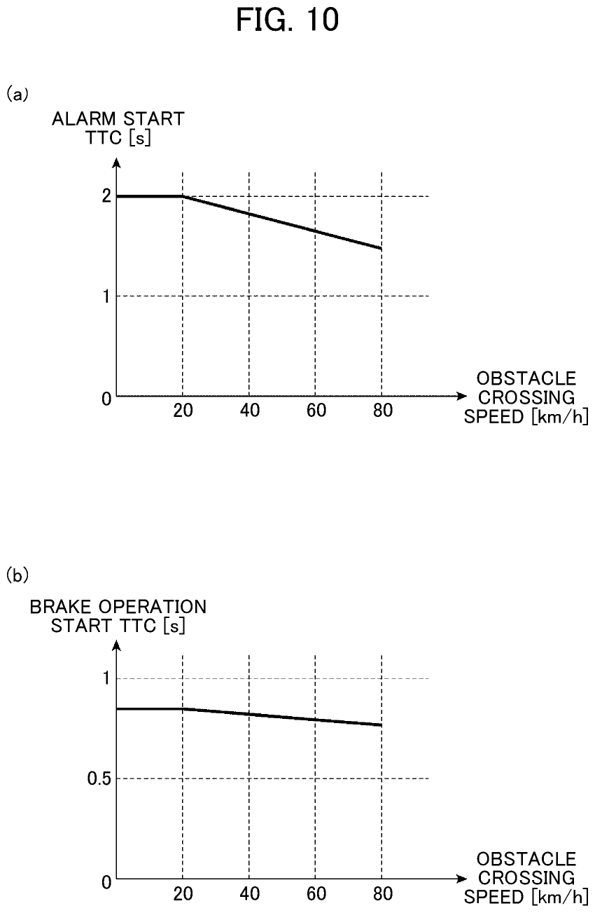

FIG. 10(a) is a diagram describing processing of setting the alert timing of the alarm. FIG. 10(b) is a diagram describing processing of setting the operation timing of the automatic emergency brake.

As described above, the vehicle control device 100 enlarges and sets the size of the ego vehicle region and/or the obstacle region in the direction crossing the course of the ego vehicle to thereby make it easier to determine that there is the possibility of the ego vehicle colliding with the obstacle. However, even in a situation in which it should not be determined that there is a possibility of collision inherently, it may be excessively determined that there is the possibility of collision. In this case, there is a possibility that the alerting of an alarm or the operation of the automatic emergency brake will be done excessively. Therefore, the vehicle control device 100 can reduce the frequency with which the alerting of the alarm or the operation of the automatic emergency brake is excessively performed, by means of such a method as shown in FIGS. 10(a) and 10(b).

Specifically, the alert control unit 41 sets the alarm start TTC set in the processing of setting the alert timing of the alarm based on the crossing speed of the obstacle as shown in FIG. 10(a). In FIG. 10(a), the faster the obstacle crossing speed, the smaller the alarm start TTC. That is, as the crossing speed of the obstacle increases, the alert control unit 41 sets the alert timing of the alarm so that the alarm is alerted at the timing when the time until collision is short (late timing). In other words, the faster the crossing speed of the obstacle, the more the alert control unit 41 waits till the very last timing before collision before alerting the alarm. Thus, even if the vehicle control device 100 enlarges and sets the size of the ego vehicle region and/or the obstacle region to make it easier to determine that there is a possibility of collision of the ego vehicle with the obstacle, the vehicle control device 100 can reduce the frequency with which the alerting of the alarm is excessively performed. The vehicle control device 100 can avoid collision with the obstacle by performing an appropriate collision assessment and appropriate driving assistance having considered the detection error of the obstacle.

Similarly, the brake control unit 42 sets the brake operation start TTC set in the processing of setting the operation timing of the automatic emergency brake, based on the crossing speed of the obstacle as shown in FIG. 10(b). In FIG. 10(b), the faster the crossing speed of the obstacle, the smaller the brake operation start TTC. That is, as the crossing speed of the obstacle increases, the brake control unit 42 sets the operation timing of the automatic emergency brake so that the automatic emergency brake is actuated at a timing when the time until collision is short. In other words, the faster the crossing speed of the obstacle, the more the brake control unit 42 waits till the very last timing before collision before activating the automatic emergency brake. Thus, even if the vehicle control device 100 enlarges and sets the size of the ego vehicle region and/or the obstacle region to make it easier to determine that there is a possibility of the ego vehicle colliding with the obstacle, the vehicle control device 100 can reduce the frequency with which the operation of the automatic emergency brake is excessively done. The vehicle control device 100 can avoid collision with the obstacle by performing an appropriate collision assessment and appropriate driving assistance having considered the detection error of the obstacle.

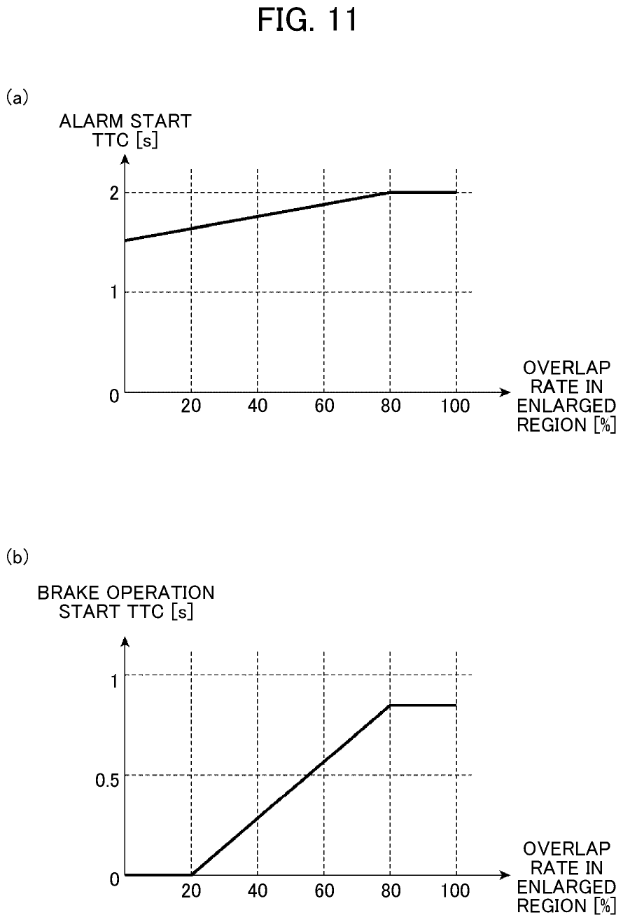

FIG. 11(a) is a diagram describing another example of the setting processing shown in FIG. 10(a). FIG. 11(b) is a diagram describing another example of the setting processing shown in FIG. 10(b).

As described above, when the size of the ego vehicle region and/or the obstacle region is enlarged, the overlap assessment unit 34 calculates the overlap rate of the ego vehicle region and the obstacle region in the enlarged region. When it is determined that the ego vehicle region and the obstacle region overlap in the region in which the size of the ego vehicle region and/or the obstacle region is enlarged, the reliability of the result of its determination is reduced if the detection error of the obstacle is large, and there is also a possibility that the determination result is an erroneous determination. Then, the smaller the overlap rate in the enlarged region, the lower the reliability of the determination result. In this case, it may be excessively determined that there is a possibility of collision even in a situation in which it should not be determined that there is a possibility of collision inherently. There is a possibility that the alerting of the alarm or the operation of the automatic emergency brake is excessively done.

The alert control unit 41 can set the alarm start TTC set in the setting processing of the alert timing of the alarm, based on the overlap rate in the enlarged region as shown in FIG. 11(a). In FIG. 11(a), the smaller the overlap rate in the enlarged region, the smaller the alarm start TTC. That is, as the overlap rate in the enlarged region decreases, the alert control unit 41 sets the alert timing of the alarm so that the alarm is alerted at the timing when the time to collision is short. In other words, the alert control unit 41 waits until the very last timing before the collision to alert the alarm as the overlap rate in the enlarged region is smaller. Thus, even if the vehicle control device 100 enlarges and sets the size of the ego vehicle region and/or the obstacle region to make it easier to determine that there is a possibility of collision of the ego vehicle with the obstacle, the vehicle control device 100 can reduce the frequency with which the alerting of the alarm is excessively done. The vehicle control device 100 can avoid collision with the obstacle by performing an appropriate collision assessment and appropriate driving assistance having considered the detection error of the obstacle.

Similarly, the brake control unit 42 sets the brake operation start TTC set in the processing of setting the operation timing of the automatic emergency brake, based on the overlap rate in the enlarged region as shown in FIG. 11(b). In FIG. 11(b), the smaller the overlap rate in the enlarged region, the smaller the brake operation start TTC. That is, as the overlap rate in the enlarged region decreases, the brake control unit 42 sets the operation timing of the automatic emergency brake so that the automatic emergency brake is actuated at a timing when the time to collision is short. In other words, the smaller the overlap rate in the enlarged region, the more the brake control unit 42 waits till the very last timing before collision before activating the automatic emergency brake. Thus, even if the vehicle control device 100 enlarges and sets the size of the ego vehicle region and/or the obstacle region to make it easier to determine that there is a possibility of the ego vehicle colliding with the obstacle, the vehicle control device 100 can reduce the frequency with which the operation of the automatic emergency brake is excessively performed. The vehicle control device 100 can avoid collision with the obstacle by performing an appropriate collision assessment and appropriate driving assistance having considered the detection error of the obstacle.

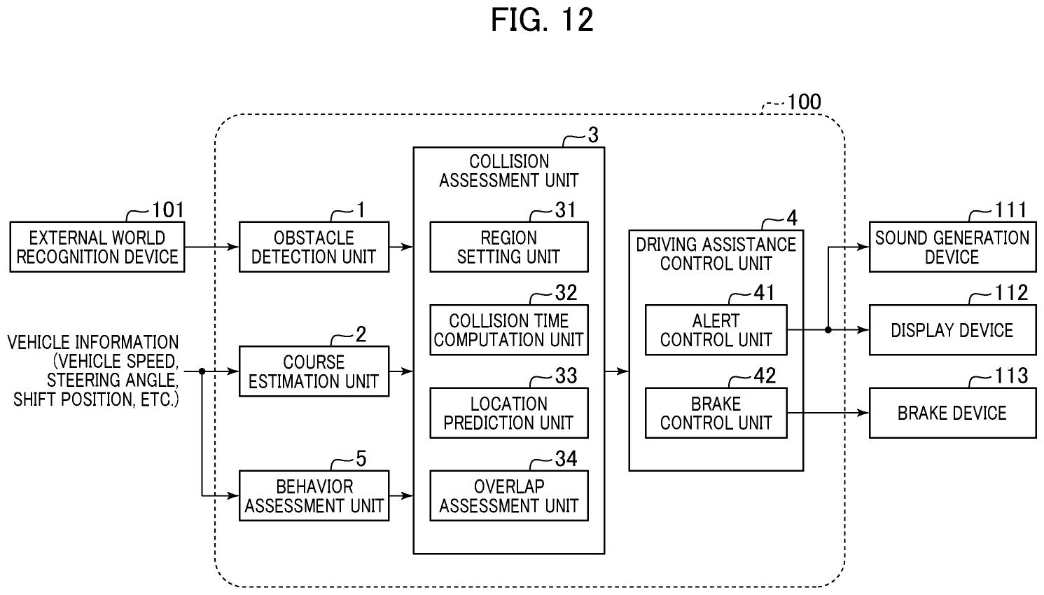

FIG. 12 is a diagram describing another example of the vehicle control device 100 shown in FIG. 1.

The vehicle control device 100 shown in FIG. 12 further includes a behavior assessment unit 5 which assesses the stability of a running behavior of an ego vehicle. The behavior assessment unit 5 assesses that the stability of the running behavior is low as the fluctuation width of a steering angle or a yaw angle of an ego vehicle included in the vehicle information of the ego vehicle input from the transmission line connected to the vehicle control device 100 increases.

When the stability is high, the reliability of the estimation result of the course estimation unit 2 tends to be high, and the detection error of the obstacle also tends to be small. Therefore, the reliability of the result of determining whether or not the ego vehicle region and the obstacle region overlap using the enlarged region can be high. On the other hand, when the stability is low, the reliability of the estimation result of the course estimation unit 2 tends to be low, and the detection error of the obstacle also tends to be large. Therefore, the reliability of the result of determining whether or not the ego vehicle region and the obstacle region overlap using the enlarged region can be low. Therefore, when the stability is low, it may be excessively determined that there is a possibility of collision even in a situation in which it should not be determined that there is a possibility of collision inherently. There is a possibility that the alerting of an alarm or the operation of the automatic emergency brake will be performed excessively.

Therefore, when the size of the ego vehicle region and/or the obstacle region is enlarged, and the stability is lower than a threshold value, the overlap assessment unit 34 invalidates the region whose size has been enlarged, and assesses whether or not the ego vehicle region and the obstacle region overlap. As a result, the overlap assessment unit 34 can accurately assess the possibility of collision of the ego vehicle with the obstacle, and can reduce the frequency with which the alerting of the alarm or the operation of the automatic emergency brake is performed excessively. The vehicle control device 100 can avoid collision with the obstacle by performing an appropriate collision assessment and appropriate driving assistance having considered the detection error of the obstacle.

### Others

It should be noted that the present invention is not limited to the examples described above, and includes various modification examples. For example, the examples described above have been described in detail to simply describe the present invention, and are not necessarily required to include all the described configurations. In addition, part of the configuration of one example can be replaced with the configurations of other examples, and in addition, the configuration of the one example can also be added with the configurations of other examples. In addition, part of the configuration of each of the examples can be subjected to addition, deletion, and replacement with respect to other configurations.

Further, each of the above configurations, functions, processing units, processing means, etc. may be realized by hardware, for example, by designing them in integrated circuits, etc. with regards to some or all thereof. In addition, each of the above configurations, functions, etc. may be realized by software by a processor interpreting and executing a program realizing each function. Information such as a program, a tape, a file, etc. which implement each function can be stored in a recording device such as a memory, a hard disk, an SSD (solid state drive), or the like, or a recording medium such as an IC card, an SD card, a DVD, or the like.

In addition, the control lines and information lines indicate what is considered to be necessary for description and does not necessarily indicate all control lines and information lines on the product. In practice, it may be considered that almost all configurations are interconnected.

### LIST OF REFERENCE SIGNS

1: obstacle detection unit
2: course estimation unit
3: collision assessment unit
31: region setting unit
32: collision time computation unit
33: location prediction unit
34: overlap assessment unit
4: driving assistance control unit
41: alert control unit
42: brake control unit
5: behavior assessment unit
100: vehicle control device
101: external world recognition device
500: ego vehicle
510: ego vehicle region
600: obstacle
610: obstacle region
620: future location

1. A vehicle control device, comprising:
an obstacle detection unit which detects an obstacle in front of an ego vehicle in a traveling direction of the ego vehicle;
a course estimation unit which estimates a course of the ego vehicle;
a collision assessment unit which assesses whether or not there is a possibility that the ego vehicle will collide with the obstacle; and
a driving assistance control unit which provides the ego vehicle with driving assistance for avoiding collision with the obstacle when it is determined that there is the possibility of collision, wherein
the collision assessment unit includes:
a region setting unit which sets an ego vehicle region in which the ego vehicle exists, and an obstacle region in which the obstacle exits,
a location prediction unit which predicts future locations of the ego vehicle region and the obstacle region on the basis of a detection result of the obstacle detection unit and an estimation result of the course estimation unit, and
an overlap assessment unit which assesses whether or not the ego vehicle region and the obstacle region overlap at the future location, and assesses that the collision possibility exists when the ego vehicle region and the obstacle region overlap, and
the region setting unit changes the size of the ego vehicle region and/or the obstacle region from the size of the ego vehicle and/or the obstacle, on the basis of a moving speed of the obstacle, to set the ego vehicle region and the obstacle region.

2. The vehicle control device according to claim 1, wherein the region setting unit changes, on the basis of the moving speed of the obstacle in a direction crossing the course of the ego vehicle, the size of the ego vehicle region and/or the obstacle region in the crossing direction from the size of the ego vehicle and/or the obstacle in the crossing direction, to set the ego vehicle region and the obstacle region.

3. The vehicle control device according to claim 1, wherein the region setting unit sets the size of the ego vehicle region and/or the obstacle region so as to be enlarged as the moving speed of the obstacle becomes faster.

4. The vehicle control device according to claim 3, wherein the region setting unit sets the size of the ego vehicle region and/or the obstacle region so as to be reduced as the moving speed of the obstacle becomes slower.

5. The vehicle control device according to claim 1, wherein
the obstacle detection unit detects the obstacle on the basis of a recognition result of an external world recognition device which recognizes a surrounding environment of the ego vehicle, and
the region setting unit changes the size of the ego vehicle region and/or the obstacle region on the basis of characteristics related to a recognition error of the external world recognition device.

6. The vehicle control device according to claim 1, wherein
the obstacle detection unit detects a type of the obstacle, and
the region setting unit changes the size of the ego vehicle region and/or the obstacle region on the basis of the type of the obstacle.

7. The vehicle control device according to claim 1, wherein
the driving assistance control unit includes a brake control unit that controls the operation of an automatic emergency brake of the ego vehicle, and
the brake control unit sets an operation timing of the automatic emergency brake on the basis of the moving speed of the obstacle.

8. The vehicle control device according to claim 1, wherein
the driving assistance control unit includes an alert control unit which controls alerting of an alarm to an occupant of the ego vehicle, and
the alert control unit sets an alert timing of the alarm on the basis of moving speed of the obstacle.

9. The vehicle control device according to claim 1, wherein
the driving assistance control unit includes a brake control unit which controls an operation of an automatic emergency brake of the ego vehicle,
when the size of the ego vehicle region and/or the obstacle region is enlarged, the overlap assessment unit calculates an overlap rate of the ego vehicle region and the obstacle region in the region whose size has been enlarged, and
the brake control unit sets an operation timing of the automatic emergency brake on the basis of the overlap rate.

10. The vehicle control device according to claim 1, wherein
the driving assistance control unit includes an alert control unit which controls alerting of an alarm to an occupant of the ego vehicle,
when the size of the ego vehicle region and/or the obstacle region is enlarged, the overlap assessment unit calculates an overlap rate of the ego vehicle region and the obstacle region in the region whose size has been enlarged, and
the alert control unit sets an alert timing of the alarm on the basis of the overlap rate.

11. The vehicle control device according to claim 1, further including a behavior assessment unit which assesses the stability of a traveling behavior of the ego vehicle,
wherein when the size of the ego vehicle region and/or the obstacle region is enlarged and the stability is lower than a threshold value, the overlap assessment unit invalidates the region whose size has been enlarged, and assesses whether or not the ego vehicle region and the obstacle region overlap.
